(19) United States
(12) Patent Application Publication
(10) Pub. No.: US 2023/0204457 A1
(43) Pub. Date: Jun. 29, 2023

(54) DIAGNOSIS DEVICE, DIAGNOSIS METHOD, AND DIAGNOSIS PROGRAM

(71) Applicant: MITSUBISHI HEAVY INDUSTRIES, LTD., Tokyo (JP)

(72) Inventors: Kyota Tokuyama, Tokyo (JP); Ichiro Awaya, Tokyo (JP); Tomohiro Ikawa, Tokyo (JP); Junya Takida, Tokyo (JP); Kimihito Obase, Tokyo (JP); Genki Nakai, Tokyo (JP)

(73) Assignee: MITSUBISHI HEAVY INDUSTRIES, LTD., Tokyo (JP)

(21) Appl. No.: 17/927,246

(22) PCT Filed: May 24, 2021
(86) PCT No.: PCT/JP2021/019494

§ 371 Date: Nov. 22, 2022

(30) Foreign Application Priority Data
May 27, 2020 (JP) 2020-092219

(51) Int. Cl. G01M 13/02

(52) U.S. Cl. CPC G01M 13/02

(57) ABSTRACT

Provided is a diagnosis device that can determine the status of an anomaly besides the presence of an anomaly of a driven member. The diagnosis device is configured to diagnose a driven member having a rotary shaft, the driven member is rotated by driving of an externally mounted motor, and the diagnosis device calculates an estimated torque resistance of a combination of the driven member and the motor based on actual operation data obtained by driving the driven member by using the motor and finds a driven member and motor three-dimensional table that is a three-dimensional table of angles, angular velocities, and estimated torque resistances, finds a reference-state three-dimensional table that is a three-dimensional table of angles, angular velocities, and estimated torque resistances in a reference state, and calculates a determination three-dimensional table from a difference between the driven member and motor three-dimensional table and the reference-state three-dimensional table.

### BACKGROUND

### 1. Technical Field

The present disclosure relates to a diagnosis device, a diagnosis method, and a diagnosis program for diagnosing a driven member having a rotary shaft.

### 2. Description of Related Art

Driven members having a rotary shaft, such as a turbo pump of a rocket engine, a machine tool, or the like are subjected to soundness diagnosis in a timely manner in order to evaluate soundness as the machine. Since driven members are unable to be driven by itself, a driven member, when diagnosed, is manually rotated by a skilled worker, and it is diagnosed whether or not there is an anomaly.

However, diagnosis based on worker’s experience relies on a sense or a skill level of the worker, and this makes it difficult to maintain a certain level of quality.

Accordingly, as disclosed in Japanese Patent Application Laid-Open No. 2007-219991, it is considered to drive a driven member by using a motor. Japanese Patent Application Laid-Open No. 2007-219991 discloses that it is determined that an anomaly has occurred when the rotation speed of the motor rises above a predetermined reference speed and estimated disturbance torque of the motor falls below predetermined reference torque.

Japanese Patent Application Laid-Open No. 2007-219991 is an example of the related art.

The above invention disclosed in Japanese Patent Application Laid-Open No. 2007-219991 has a problem that, since diagnosis is performed with two variables of a rotation speed and a disturbance torque value of a motor, the diagnosis is solely intended for determination of the presence or absence of an anomaly in the driven member to be diagnosed.

### BRIEF SUMMARY

The present disclosure has been made in view of such circumstances, and an object is to provide a diagnosis device, a diagnosis method, and a diagnosis program that can determine the occurrence status of an anomaly in addition to the presence or absence of an anomaly of a driven member.

To achieve the above object, a diagnosis device of the present disclosure is a diagnosis device configured to diagnose a driven member having a rotary shaft, the driven member is rotated by driving of an externally mounted motor, and the diagnosis device is configured to: calculate an estimated torque resistance value of a combination of the driven member and the motor based on actual operation data obtained by driving the driven member by using the motor and find a driven member and motor three-dimensional table that is a three-dimensional table of angles, angular velocities, and the estimated torque resistance value; find a reference-state three-dimensional table that is a three-dimensional table of angles, angular velocities, and estimated torque resistance values in a reference state; and calculate a determination three-dimensional table from a difference between the driven member and motor three-dimensional table and the reference-state three-dimensional table.

To achieve the above object, a diagnosis method of the present disclosure is a diagnosis method for diagnosing a driven member having a rotary shaft, the driven member is rotated by driving of an externally mounted motor, and the diagnosis method includes: calculating an estimated torque resistance value of a combination of the driven member and the motor based on actual operation data obtained by driving the driven member by using the motor and finding a driven member and motor three-dimensional table that is a three-dimensional table of angles, angular velocities, and the estimated torque resistance value; finding a reference-state three-dimensional table that is a three-dimensional table of angles, angular velocities, and estimated torque resistance values in a reference state; and calculating a determination three-dimensional table from a difference between the driven member and motor three-dimensional table and the reference-state three-dimensional table.

To achieve the above object, a diagnosis program of the present disclosure is a diagnosis program for diagnosing a driven member having a rotary shaft, the driven member is rotated by driving of an externally mounted motor, and the diagnosis program includes steps of: calculating an estimated torque resistance value of a combination of the driven member and the motor based on actual operation data obtained by driving the driven member by using the motor and finding a driven member and motor three-dimensional table that is a three-dimensional table of angles, angular velocities, and the estimated torque resistance value; finding a reference-state three-dimensional table that is a three-dimensional table of angles, angular velocities, and estimated torque resistance values in a reference state; and calculating a determination three-dimensional table from a difference between the driven member and motor three-dimensional table and the reference-state three-dimensional table.

According to the present disclosure, since a three-dimensional table is used, it is possible to determine the occurrence status of an anomaly in addition to the presence or absence of an anomaly.

Further, since a motor is used to diagnose a driven member, a manual operation performed by a skilled worker is not required, and consistency in the quality of inspection can be achieved.

### BRIEF DESCRIPTION OF THE SEVERAL VIEWS OF THE DRAWINGS

FIG. 1 is a flowchart illustrating control of a diagnosis device in some embodiments of the present disclosure.

FIG. 2 is a diagram illustrating time charts each representing an angle and torque for each angular velocity in the diagnosis device in some embodiments of the present disclosure.

FIG. 3 is a diagram illustrating a relationship between an angle and an estimated torque resistance value for each angular velocity in the diagnosis device in some embodiments of the present disclosure.

FIG. 4 is a diagram of a three-dimensional table of angles, angular velocities, and estimated torque resistance values in the diagnosis device in some embodiments of the present disclosure.

FIG. 5 is a diagram of three-dimensional tables of angles, angular velocities, and estimated torque resistance values in a normal state in the diagnosis device in some embodiments of the present disclosure.

FIG. 6 is a diagram of three-dimensional tables of angles, angular velocities, and estimated torque resistance values in an abnormal state in the diagnosis device in some embodiments of the present disclosure.

FIG. 7 is a diagram of an anomaly distribution acquired by the diagnosis device in some embodiments of the present disclosure.

FIG. 8 is a diagram of three-dimensional tables of angles, angular velocities, and estimated torque resistance values in a normal state in the diagnosis device in some embodiments of the present disclosure.

FIG. 9 is a diagram of three-dimensional tables of angles, angular velocities, and estimated torque resistance values in an abnormal state in the diagnosis device in some embodiments of the present disclosure.

FIG. 10 is a diagram including three-dimensional tables of angles, angular velocities, and estimated torque resistance values and a graph of an average value of estimated torque resistance values in a normal state in the diagnosis device in some embodiments of the present disclosure.

FIG. 11 is a diagram including three-dimensional tables of angles, angular velocities, and estimated torque resistance values and a graph of an average value of estimated torque resistance values in an abnormal state in the diagnosis device in some embodiments of the present disclosure.

FIG. 12 is a schematic configuration diagram of the diagnosis device in some embodiments of the present disclosure.

### DETAILED DESCRIPTION

Embodiments of a diagnosis device, a diagnosis method, and a diagnosis program according to the present disclosure will be described below with reference to the drawings.

FIG. 12 illustrates a diagram of a schematic configuration of the diagnosis device according to some embodiments of the present disclosure.

A diagnosis device 50 according to the present disclosure is applied to a combination of a driven member 10 having a rotary shaft and an externally mounted motor 20 configured to rotate the driven member 10.

The driven member 10 is unable to rotate by itself. The driven member 10 may be, for example, a turbo pump of a rocket engine, a machine tool, or the like, and any type of members may be employed as long as it has a rotary shaft.

The motor 20 is a motor externally mounted to the driven member 10 when diagnosed by the diagnosis device 50. During diagnosis, the driven member 10 is rotated by driving of the motor 20.

The diagnosis device 50 is a device that diagnoses soundness of the driven member 10, for example, and acquires operation data from the motor 20 to perform diagnosis.

The diagnosis device 50 is formed of a central processing unit (CPU), a random access memory (RAM), a read only memory (ROM), a computer readable non-transitory storage medium, and the like, for example. Further, a series of processes for implementing respective functions is stored in a storage medium or the like in a form of a program as an example, and when the CPU loads the program into the RAM or the like and performs a processing and calculation process on information, respective functions are implemented. Note that an applicable form of the program may be a form in which a program is installed in advance in a ROM or another storage medium, a form in which a program is provided in a state of being stored in a computer readable storage medium, a form in which a program is delivered via a wired or wireless communication scheme, or the like. The computer readable storage medium may be a magnetic disk, a magneto-optical disk, a CD-ROM, a DVD-ROM, a semiconductor memory, or the like.

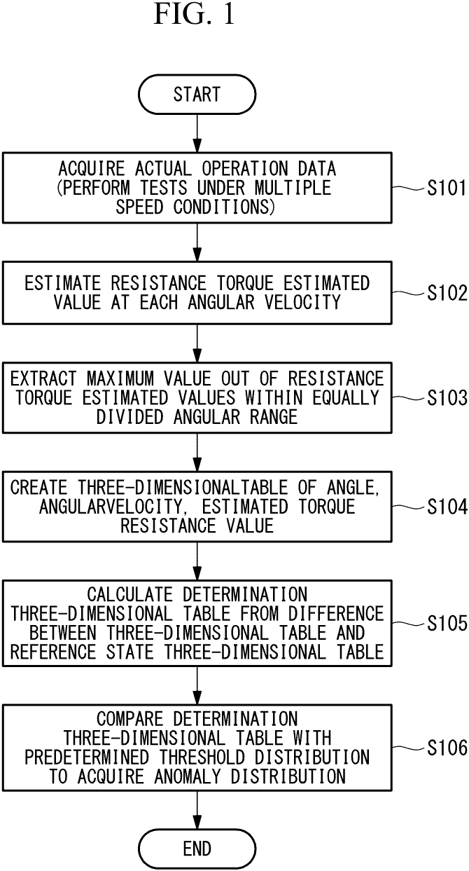

FIG. 1 illustrates a flowchart of control of the diagnosis device according to some embodiments of the present disclosure.

Once starting diagnosis of the driven member 10, the diagnosis device 50 drives the driven member 10 by using the motor 20 and acquires actual operation data (S101). The actual operation data is acquired by performing a test under a plurality of speed conditions. The acquired actual operation data includes characteristics of the driven member 10 and the motor 20.

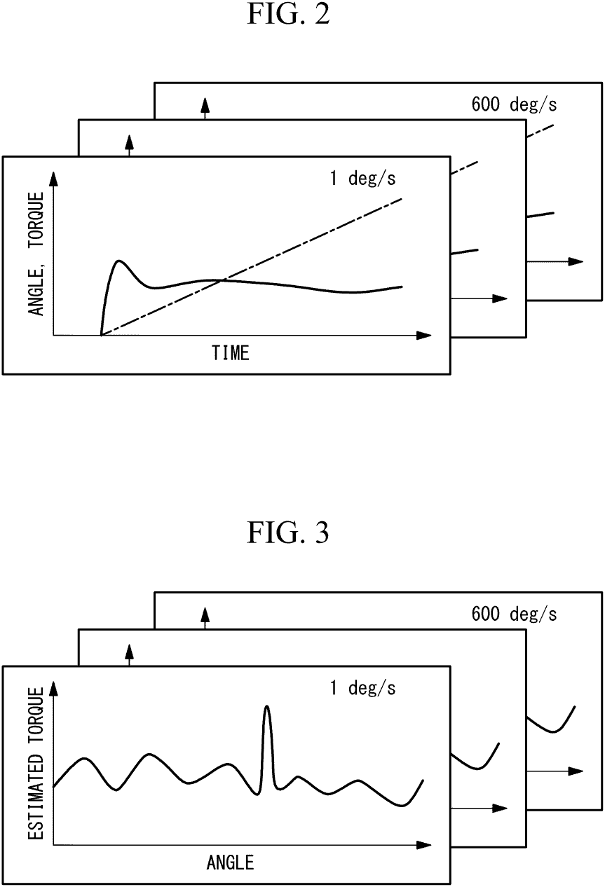

FIG. 2 illustrates time charts each representing an angle and an estimated torque resistance value for each angular velocity in the diagnosis device in some embodiments of the present disclosure.

As illustrated in FIG. 2, the diagnosis device 50 acquires a time chart of the angle and the torque at a constant angular velocity for a combination of the driven member 10 and the motor 20. In the graph of FIG. 2, the vertical axis represents the angle or the torque, the horizontal axis represents time, the dot-chain line represents a time chart of the angle, and the solid line represents a time chart of the torque. The angle exhibits substantially a straight line rising to the right to be proportional to time. The torque initially increases steeply, exhibits a peak value, then decreases, and finally converges within a certain range.

The diagnosis device 50 of the present embodiment performs tests of 600 patterns in total for angular velocities from 1 deg/s to 600 deg/s on a 1 deg/s basis and acquires actual operation data as time-series data. Note that values of angular velocities or sections of angular velocities of actual operation data acquired by the diagnosis device 50 are mere examples. For example, a driven angular velocity range of the driven member 10 may be reflected to the values of angular velocities of actual operation data. Further, for example, a section of angular velocities may be of any resolution as long as it enables determination of a distribution in an abnormal state, and each section may correspond to 5 deg/s or the like, for example.

Next, in step S102 of FIG. 1, the diagnosis device 50 calculates an estimated torque resistance value at each angular velocity.

While various methods may be employed for estimation of resistance torque, such as using a torque sensor that performs estimation at a disturbance observer, any method may be used for the estimation. Further, calculation of an estimated torque resistance value is performed in a state where the speeds of the driven member 10 and the motor 20 are stable except for a state immediately after startup or the like.

FIG. 3 illustrates a relationship between the angle and the estimated torque resistance value for each an angular velocity in the diagnosis device in some embodiments of the present disclosure.

In the graph of FIG. 3, the vertical axis represents the estimated torque resistance value, and the horizontal axis represents the angle. The diagnosis device 50 of the present embodiment estimates an estimated torque resistance value at each angular velocity to acquire an estimated torque resistance value table from the actual operation data acquired by performing tests of 600 patterns in total for angular velocities from 1 deg/s to 600 deg/s on a 1 deg/s basis as described above.

Next, in step S103 of FIG. 1, the diagnosis device 50 extracts the maximum value out of the estimated torque resistance values within each of equally divided angular ranges.

The diagnosis device 50 equally divides the estimated torque resistance value table of FIG. 3 for each angular velocity on a 1 degree basis, for example, and extracts the maximum values of the estimated torque resistance values within respective angular ranges on an angular range basis. Note that each angular range is 1 degree in the present embodiment but may be of any resolution as long as it enables determination of a distribution in an abnormal state and may be 5 degrees or the like, for example.

Next, in step S104 of FIG. 1, the diagnosis device 50 creates a three-dimensional table of angles, angular velocities, and estimated torque resistance values.

The diagnosis device 50 defines the angular velocity in the radial direction (angular velocity instruction (logarithm)), defines the equally divided angle in the angular direction (the circumferential direction), and defines the estimated torque resistance value (the maximum value) in the axial direction (the height direction) in a cylindrical coordinate system to create a three-dimensional table.

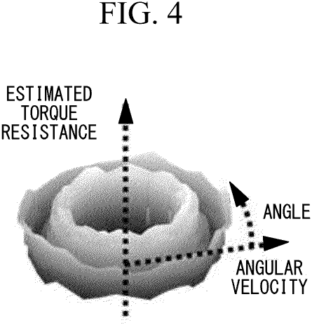

FIG. 4 illustrates a three-dimensional table of angles, angular velocities, and estimated torque resistance values in the diagnosis device in some embodiments of the present disclosure.

As illustrated in FIG. 4, the three-dimensional table of angles, angular velocities, and estimated torque resistance values indicates that a lighter color expresses a larger estimated torque resistance value in the positive direction, and a darker color expresses a larger estimated torque resistance value in the negative direction. The three-dimensional table of angles, angular velocities, and estimated torque resistance values can have input of angles and angular velocities and provide output of estimated torque resistance values and thus can be said as a distribution of the estimated torque resistance values.

Next, in step S105 of FIG. 1, the diagnosis device 50 calculates a determination three-dimensional table from a difference between the three-dimensional table acquired in step S104 and a reference-state three-dimensional table.

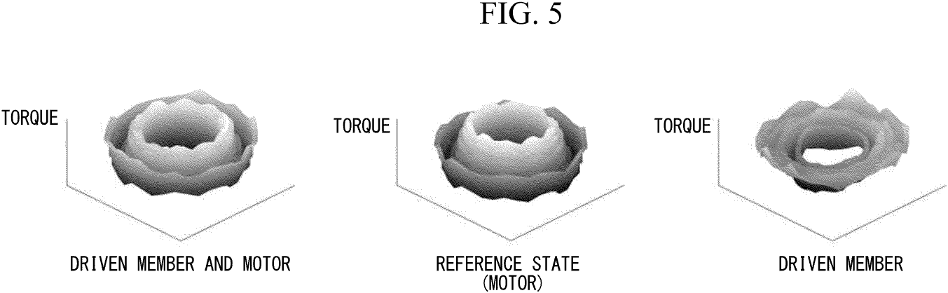

FIG. 5 illustrates three-dimensional tables of angles, angular velocities, and estimated torque resistance values in a normal state in the diagnosis device in some embodiments of the present disclosure.

The normal state as used in the present disclosure is defined as a state in a normal period except for an abnormal state where an anomaly is ongoing.

The left view of FIG. 5 illustrates a three-dimensional table for the driven member 10 and the motor 20. The center view of FIG. 5 illustrates a three-dimensional table for the motor 20 in a reference state described later. The right view of FIG. 5 illustrates a three-dimensional table for only the driven member 10.

The diagnosis device 50 acquires a reference-state three-dimensional table in advance. The reference state in the present embodiment is defined as a state where only the motor 20, which drives and rotates the driven member 10 in the diagnosis of the driven member 10, is driven. The diagnosis device 50 calculates a motor estimated torque resistance value that is an estimated torque resistance value for only the motor 20 based on motor operation data obtained by driving only the motor 20 and acquires a three-dimensional table for the motor 20 in advance, which is a three-dimensional table of angles, angular velocities, and motor estimated torque resistance values, as the reference-state three-dimensional table in the present embodiment.

The diagnosis device 50 calculates a difference between the three-dimensional table acquired in step S104 of FIG. 1 (see the left view of FIG. 5) and the three-dimensional table for the motor 20 acquired in advance (see the center view of FIG. 5). This difference corresponds to a three-dimensional table for only the driven member 10 to be diagnosed by the diagnosis device 50 (the determination three-dimensional table) (see the right view of FIG. 5).

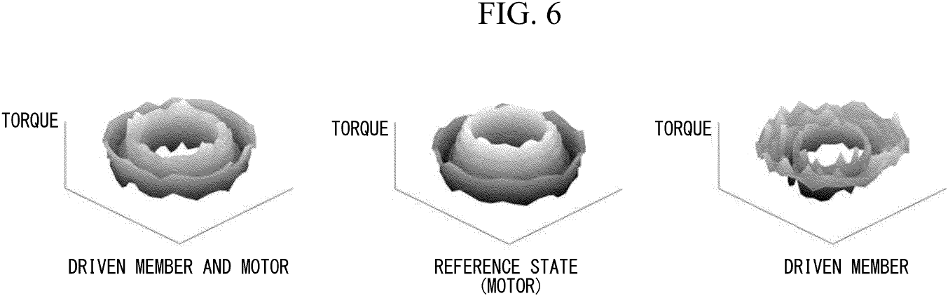

FIG. 6 illustrates three-dimensional tables of angles, angular velocities, and estimated torque resistance values in an abnormal state in the diagnosis device in some embodiments of the present disclosure.

The left view of FIG. 6 illustrates a three-dimensional table for the driven member 10 and the motor 20 in an abnormal state. The center view of FIG. 6 illustrates a three-dimensional table for the motor 20 in the reference state for the abnormal state. The right view of FIG. 6 illustrates a three-dimensional table for only the driven member 10 in the abnormal state.

When performing diagnosis, the diagnosis device 50 performs the process of steps S101 to S105 of FIG. 1 to acquire a three-dimensional table for only the driven member 10 to be diagnosed.

For example, the left view of FIG. 6 illustrates a three-dimensional table for the driven member 10 and the motor 20 in a case where a foreign material having a size of 5 µm enters the driven member 10, that is, in an abnormal state.

The diagnosis device 50 calculates a difference between the three-dimensional table for the driven member 10 and the motor 20 in the abnormal state (see the left view of FIG. 6) and the three-dimensional table for the motor 20 acquired in advance (see the center view of FIG. 6). This difference corresponds to a three-dimensional table for only the driven member 10 to be diagnosed by the diagnosis device 50 in the abnormal state (the determination three-dimensional table) (see the right view of FIG. 6).

The worker performing the diagnosis is able to determine whether or not there is an anomaly by visually comparing the found three-dimensional table for only the driven member 10 in the normal state (see the right view of FIG. 5) with the three-dimensional table for only the driven member 10 to be diagnosed by the diagnosis device 50 in the abnormal state (see the right view of FIG. 6). Further, it is possible to sense an angle or an angular velocity at which an anomaly of the driven member 10 may be ongoing and to identify the position of the anomaly and the cause of the anomaly.

Furthermore, if a clear diagnosis result is required, the process proceeds to step S106.

In step S106, the diagnosis device 50 compares the three-dimensional table for only the driven member 10, which is the determination three-dimensional table, with a predetermined threshold distribution described later to acquire an anomaly distribution.

The diagnosis device 50 acquires a predetermined threshold distribution in advance.

The diagnosis device 50 acquires a normal-state three-dimensional table for the driven member 10, which is a three-dimensional table of angles, angular velocities, and estimated torque resistance values in a normal state (for example, when the driven member 10 is in an initial state (new article)) that is not an abnormal state but is a normal state. Based on this normal-state three-dimensional table for the driven member 10, the distribution of thresholds for estimated torque resistance values in the normal state is set as a predetermined threshold distribution.

The diagnosis device 50 compares the three-dimensional table for only the driven member 10 with the predetermined threshold distribution to acquire an anomaly distribution. In such a way, the anomaly distribution is output in binary values, namely, normalcy or anomaly in accordance with the comparison between the three-dimensional table for only the driven member 10 with a threshold. The normalcy and anomaly may be output in binary values of 0 or 1.

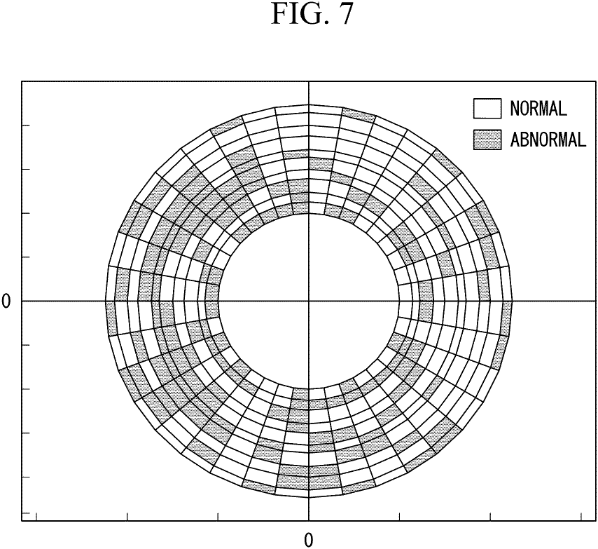

FIG. 7 illustrates an anomaly distribution acquired by the diagnosis device in some embodiments of the present disclosure.

In FIG. 7, the radial direction of the circle represents the angular velocity, the angular direction (circumferential direction) of the circle represents the angle, and the distribution is acquired with the angular range being defined as 10 degrees. In FIG. 7, each white part represents that the estimated torque resistance value is normal (there is no anomaly), and each black part represents that the estimated torque resistance value is abnormal. In such a way, by acquiring an anomaly distribution, it is possible to list angles and angular velocities at which an anomaly is ongoing in the driven member 10, and it is thus possible to identify an accurate cause of the anomaly.

Although the case where the reference-state three-dimensional table is the three-dimensional table for the motor 20 has been described in the embodiment described above, a case where the reference-state three-dimensional table is a three-dimensional table for the driven member 10 and the motor 20 in a predetermined state that is a set predetermined state will be described in the present embodiment. The diagnosis device 50 according to the present embodiment will be described below mainly for features different from those in the embodiment described previously.

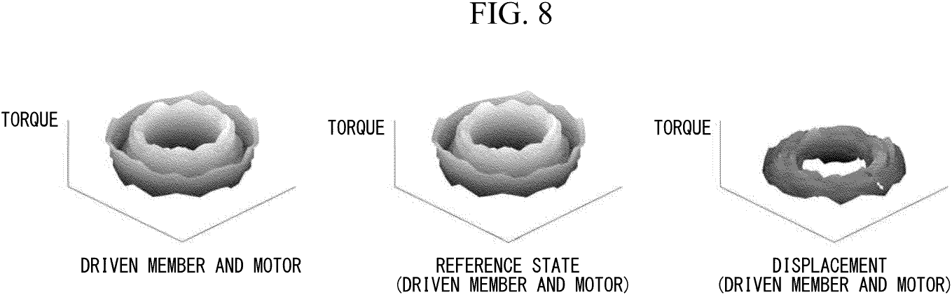

FIG. 8 illustrates a three-dimensional table of angles, angular velocities, and estimated torque resistance values in a normal state in the diagnosis device in some embodiments of the present disclosure.

The left view of FIG. 8 illustrates three-dimensional tables for the driven member 10 and the motor 20 at a point of time of diagnosis performed by the diagnosis device 50. The center view of FIG. 8 illustrates a three-dimensional table for the driven member 10 and the motor 20 in a predetermined state that is a reference state described later. The right view of FIG. 8 illustrates a three-dimensional table of displacements of the driven member 10 and the motor 20.

The diagnosis device 50 acquires a reference-state three-dimensional table in the present embodiment in advance. The reference state of the present embodiment represents a predetermined state that is a set predetermined state. Specifically, the reference state may be, for example, a normal state that is not an abnormal state described above, a state at a set predetermined point of time that is a reference for diagnosis or at a point of time of the day before the diagnosis time, or the like. In the present embodiment, the set predetermined state is a normal state where the driven member 10 and the motor 20 are not in an abnormal state.

The diagnosis device 50 calculates an estimated torque resistance value in a predetermined state for a combination of the driven member 10 and the motor 20 based on a predetermined state operation data obtained when the driven member 10 is driven by the motor 20 at a point of time in a set predetermined state, that is, a normal state and acquires the three-dimensional table for the driven member 10 and the motor 20 in a predetermined state in advance, which is the three-dimensional table of angles, angular velocities, and estimated torque resistance values in the predetermined state, as the reference-state three-dimensional table in the present embodiment.

The diagnosis device 50 in the present embodiment performs the process of steps S101 to S105 of FIG. 1 to acquire a three-dimensional table of displacements.

The diagnosis device 50 calculates a difference between the three-dimensional table acquired in step S104 of FIG. 1 (see the left view of FIG. 8) and the three-dimensional table for the driven member 10 and the motor 20 in the predetermined state acquired in advance (see the center view of FIG. 8). This difference corresponds to the three-dimensional table of displacements from a predetermined state (in the case of the present embodiment, the normal state) set for the driven member 10 and the motor 20 (the determination three-dimensional table) (see the right view of FIG. 8). A change from a set predetermined state, for example, a normal state can be understood from the above three-dimensional table of displacements, and a displacement from the previous time (in this case, aging degradation) can be evaluated.

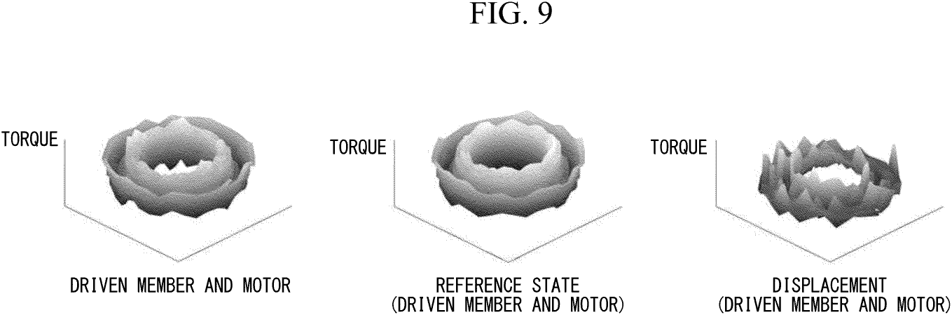

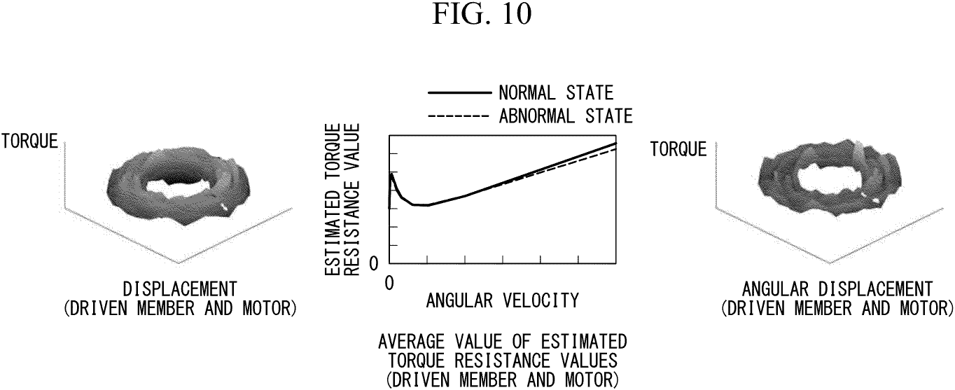

FIG. 9 illustrates three-dimensional tables of angles, angular velocities, and estimated torque resistance values in an abnormal state in the diagnosis device in some embodiments of the present disclosure.

The left view of FIG. 9 illustrates three-dimensional tables for the driven member 10 and the motor 20 in an abnormal state. The center view of FIG. 9 illustrates a three-dimensional table for the driven member 10 and the motor 20 in a predetermined state that is the reference state for the abnormal state. The right view of FIG. 9 illustrates a three-dimensional table of displacements of the driven member 10 and the motor 20 in the abnormal state.

When performing diagnosis, the diagnosis device 50 performs the process of steps S101 to S105 of FIG. 1 to acquire a three-dimensional table of displacements.

For example, the left view of FIG. 9 illustrates a three-dimensional table for the driven member 10 and the motor 20 in a case where a foreign material having a size of 5 µm enters the driven member 10, that is, in an abnormal state.

The diagnosis device 50 calculates a difference between the three-dimensional table for the driven member 10 and the motor 20 in the abnormal state (see the left view of FIG. 9) and the three-dimensional table for the driven member 10 and the motor 20 in a predetermined state acquired in advance (see the center view of FIG. 9). This difference corresponds to a three-dimensional table of displacements from a set predetermined state (in the case of the present embodiment, the normal state) for the driven member 10 and the motor 20 in the abnormal state (the determination three-dimensional table) (see the right view of FIG. 9).

The worker performing the diagnosis is able to determine whether or not there is an anomaly that is different from aging degradation by visually comparing the found three-dimensional table of displacements of the driven member 10 and the motor 20 in the normal state (see the right view of FIG. 8) with the three-dimensional table of displacements of the driven member 10 and the motor 20 in the abnormal state (see the right view of FIG. 9). Further, it is possible to sense an angle or an angular velocity at which an anomaly of the driven member 10 may be ongoing and to identify the position of the anomaly and the cause of the anomaly.

Although the set predetermined state is a normal state in the present embodiment, a state at a certain point of time on the time axis, such as the day before or one month before, may be the predetermined state. With the state at a certain point of time being the predetermined state, it is possible to diagnose aging degradation of the driven member 10 and the motor 20 in more detail.

Furthermore, by comparing the calculated three-dimensional table of displacements with the average value of the estimated torque resistance values at each angular velocity, it is possible to evaluate variation in displacements for each angle.

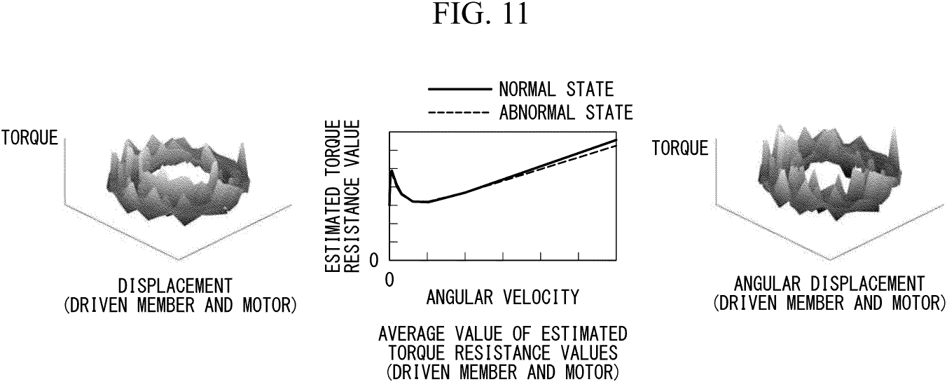

FIG. 10 illustrates three-dimensional tables of angles, angular velocities, and estimated torque resistance values in a normal state in the diagnosis device in some embodiments of the present disclosure.

The left view of FIG. 10 illustrates a three-dimensional table of displacements of the driven member 10 and the motor 20. The center view of FIG. 10 illustrates the average value of estimated torque resistance values for each angular velocity. The right view of FIG. 10 illustrates a three-dimensional table of angular displacements of the driven member 10 and the motor 20.

In the present embodiment, the diagnosis device 50 performs the process of steps S101 to S104 of FIG. 1 and acquires a three-dimensional table of displacements of the driven member 10 and the motor 20 (see the left view of FIG. 10).

Next, the diagnosis device 50 finds the average value of the estimated torque resistance values on an angular velocity basis to create the graph of the center view of FIG. 10. In the center view of FIG. 10, the vertical axis represents the estimated torque resistance value, the horizontal axis represents the angular velocity, and the solid line represents the average value of the estimated torque resistance values for each angular velocity in the normal state.

Next, the diagnosis device 50 calculates a difference between the three-dimensional table of displacements of the driven member 10 and the motor 20 (see the left view of FIG. 10) and the average value of estimated torque resistance values for each angular velocity in the normal state (see the center view of FIG. 10). This difference corresponds to the three-dimensional table of angular displacements of the driven member 10 and the motor 20 (the determination three-dimensional table) (see the right view of FIG. 10). In accordance with this three-dimensional table of angular displacements, since characteristics for respective angular velocities are subtracted, it is possible to determine at what angle the variation in one rotation exists.

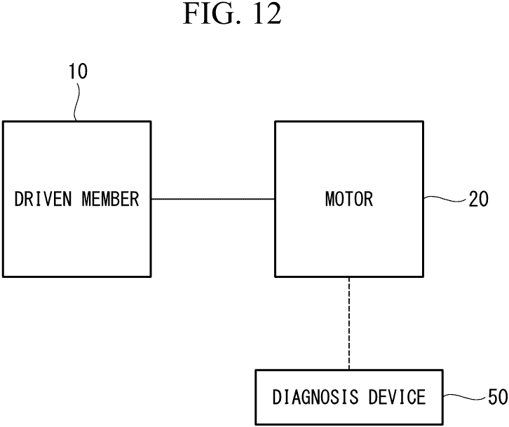

FIG. 11 illustrates three-dimensional tables of angles, angular velocities, and estimated torque resistance values in an abnormal state in the diagnosis device in some embodiments of the present disclosure.

The left view of FIG. 11 illustrates a three-dimensional table of displacements of the driven member 10 and the motor 20 in an abnormal state. The center view of FIG. 11 illustrates the average value of estimated torque resistance values for each angular velocity in the abnormal state. The right view of FIG. 11 illustrates a three-dimensional table of angular displacements of the driven member 10 and the motor 20 in the abnormal state.

In the present embodiment, the diagnosis device 50 performs the process of steps S101 to S104 of FIG. 1 to acquire a three-dimensional table of displacements of the driven member 10 and the motor 20 in the abnormal state (see the left view of FIG. 11).

For example, the left view of FIG. 11 illustrates a three-dimensional table of displacements of the driven member 10 and the motor 20 in a case where a foreign material having a size of 5 µm enters the driven member 10, that is, in an abnormal state.

Next, the diagnosis device 50 finds the average value of estimated torque resistance values on an angular velocity basis to create the graph of the center view of FIG. 11. In the center view of FIG. 11, the vertical axis represents the estimated torque resistance value, the horizontal axis represents the angular velocity, and the dashed line represents the average value of estimated torque resistance values for each angular velocity in the abnormal state.

Next, the diagnosis device 50 calculates a difference between the three-dimensional table of displacements of the driven member 10 and the motor 20 in the abnormal state (see the left view of FIG. 11) and the average value of estimated torque resistance values for each angular velocity in the abnormal state (see the center view of FIG. 11). This difference corresponds to the three-dimensional table of angular displacements of the driven member 10 and the motor 20 in the abnormal state (the determination three-dimensional table) (see the right view of FIG. 11). In accordance with this three-dimensional table of angular displacements in the abnormal state, since characteristics for respective angular velocities are subtracted, it is possible to determine at what angle the variation in one rotation exists.

The worker performing the diagnosis is able to determine whether or not there is an anomaly for each angle by visually comparing the three-dimensional table of angular displacements of the driven member 10 and the motor 20 in the normal state found in such a way (see the right view of FIG. 10) with the three-dimensional table of angular displacements of the driven member 10 and the motor 20 in the abnormal state (see the right view of FIG. 11). Further, it is possible to sense an angle at which an anomaly of the driven member 10 may be ongoing and to identify the position of the anomaly and the cause of the anomaly.

The diagnosis device, the diagnosis method, and the diagnosis program of each embodiment described above are understood as follows, for example.

The diagnosis device (50) according to the present disclosure is a diagnosis device configured to diagnose a driven member (10) having a rotary shaft, the driven member is rotated by driving of an externally mounted motor (20), and the diagnosis device calculates an estimated torque resistance value of a combination of the driven member and the motor based on actual operation data obtained by driving the driven member by using the motor and finds a driven member and motor three-dimensional table that is a three-dimensional table of angles, angular velocities, and the estimated torque resistance value, finds a reference-state three-dimensional table that is a three-dimensional table of angles, angular velocities, and estimated torque resistance values in a reference state, and calculates a determination three-dimensional table from a difference between the driven member and motor three-dimensional table and the reference-state three-dimensional table.

Since the diagnosis device according to the present disclosure uses a three-dimensional table when diagnosing soundness of a driven member, it is possible to perform more accurate diagnosis than in diagnosis in a two-dimensional manner.

Further, in the diagnosis device according to the present disclosure, since it is possible to obtain an angle and an angular velocity from a three-dimensional table, respectively, it is possible not only to know whether or not there is an anomaly but also to obtain the angle and the angular velocity at which an anomaly may be ongoing, which can contribute to identification of the position of the anomaly and the cause of the anomaly.

In the diagnosis device according to the present disclosure, since an operation performed by a skilled worker is not required in soundness diagnosis on a driven member having a rotary shaft and rotated by an externally mounted motor, consistency in the quality of soundness diagnosis or inspection on a driven member can be achieved.

Herein, the reference state refers to a state defined as a reference used in diagnosis of an anomaly of a three-dimensional table based on actual operation data, and the reference-state three-dimensional table refers to, for example, a three-dimensional table for only the motor, a three-dimensional table for the driven member and the motor on the previous day, or the like.

Further, the diagnosis device according to the present disclosure defines, as a predetermined threshold distribution, a distribution of thresholds for estimated torque resistance values in a normal state based on a normal-state three-dimensional table that is a three-dimensional table of angles, angular velocities, and estimated torque resistance values in a normal state, which is not an abnormal state, and compares the determination three-dimensional table found based on the actual operation data with the predetermined threshold distribution to output a comparison result in binary values.

In the diagnosis device according to the present disclosure, since a result of comparison of the determination three-dimensional table found based on the actual operation data with the predetermined threshold distribution, which is a distribution of thresholds based on the normal-state three-dimensional table, is obtained in binary values, it is possible not only to know the presence or absence of an anomaly but also to obtain an angle and an angular velocity at which an anomaly may be ongoing compared to the normal state, which can contribute to identification of the cause of the anomaly. Compared to a case where only the determination three-dimensional table is acquired based on operation data, it is possible to more accurately identify a cause of an anomaly in the diagnosis device according to the present disclosure.

Further, in the diagnosis device according to the present disclosure, the reference-state three-dimensional table is a motor three-dimensional table that is a three-dimensional table of angles, angular velocities, and a motor estimated torque resistance value found by calculating the motor estimated torque resistance value of the motor based on motor operation data obtained by driving only the motor, and the diagnosis device calculates a driven member three-dimensional table, which is the determination three-dimensional table, from a difference between the driven member and motor three-dimensional table and the motor three-dimensional table.

When the driven member is unable to rotate by itself, a motor is thus mounted to rotate the driven member, and soundness diagnosis is performed on the driven member, the diagnosis device according to the present disclosure can perform diagnosis on only the driven member while excluding information on the motor.

According to the diagnosis device of the present disclosure, since a three-dimensional table for only the driven member is obtained, it is possible not only to known the presence or absence of an anomaly of the driven member but also to obtain an angle and an angular velocity at which an anomaly may be ongoing, which can contribute to identification of the cause of the anomaly.

Further, the diagnosis device according to the present disclosure calculates a driven member average estimated torque resistance value, which is an average value of estimated torque resistance values of the driven member, for each of the angular velocities, and calculates a driven member displacement three-dimensional table from a difference between the driven member three-dimensional table and the driven member average estimated torque resistance value.

Since the diagnosis device according to the present disclosure calculates the average estimated torque resistance value of the driven member for each angular velocity and calculates a three-dimensional table of displacements of the driven member from a difference from the three-dimensional table for the driven member, it is possible to obtain a three-dimensional table from which characteristics of respective angular velocities are subtracted, and it is thus possible to evaluate variation in distribution on the three-dimensional table for each angle.

Further, in the diagnosis device according to the present disclosure, the reference-state three-dimensional table is a predetermined-state driven member and motor three-dimensional table that is a three-dimensional table of angles, angular velocities, and a predetermined-state estimated torque resistance value found by calculating the predetermined-state estimated torque resistance value of a combination of the driven member and the motor based on a predetermined-state operation data obtained by driving the driven member by using the motor in a set predetermined state, and the diagnosis device calculates a driven member and motor displacement three-dimensional table, which is the determination three-dimensional table, from a difference between the driven member and motor three-dimensional table and the predetermined-state driven member and motor three-dimensional table.

When the driven member is unable to rotate by itself, a motor is thus mounted to rotate the driven member, and soundness diagnosis is performed on the driven member, the diagnosis device according to the present disclosure can perform diagnosis based on displacements of the resistance torque estimated value from a predetermined state while excluding information on the driven member and motor three-dimensional table in the predetermined state that is the reference state.

According to the diagnosis device of the present disclosure, it is possible to check how much the resistance torque has changed from a predetermined state (a reference state), and it is thus possible to evaluate and determine aging degradation of the driven member in addition to the evaluation of the presence or absence of an anomaly and an angle and an angular velocity at which the anomaly may be ongoing.

Further, the diagnosis device according to the present disclosure calculates a driven member and motor average estimated torque resistance value that is an average value of estimated torque resistance values of the driven member and the motor for each of the angular velocities, and calculates a driven member and motor displacement three-dimensional table from a difference between the driven member and motor displacement three-dimensional table and the driven member and motor average estimated torque resistance value.

Since the diagnosis device according to the present disclosure calculates the driven member and motor average estimated torque resistance value for each angular velocity and calculates a three-dimensional table of displacements of the driven member and the motor from a difference from the three-dimensional table for the driven member and the motor, it is possible to obtain a three-dimensional table from which characteristics of respective angular velocities are subtracted, and it is thus possible to evaluate variation in distribution on the three-dimensional table for each angle.

Further, in the diagnosis device according to the present disclosure, the actual operation data is data on the angles and the estimated torque resistance values acquired for each of the angular velocities, and the maximum value is extracted out of the estimated torque resistance values within each of equally divided angular ranges and calculated as the estimated torque resistance value.

In the diagnosis device according to the present disclosure, since the maximum value is extracted out of the estimated torque resistance values and calculated as an estimated torque resistance value, this can make it easier to detect an anomaly of a locally increased estimated torque resistance value, an anomaly of reduced lubrication because of entry of a foreign material in a bearing, for example, or the like.

Further, in the diagnosis device according to the present disclosure, the actual operation data is data on the angles and the estimated torque resistance values acquired for each of the angular velocities, and the minimum value is extracted out of the estimated torque resistance values within each of equally divided angular ranges and calculated as the estimated torque resistance value.

In the diagnosis device according to the present disclosure, since the minimum value is extracted out of the estimated torque resistance values and calculated as an estimated torque resistance value, this can make it easier to detect an anomaly of a locally reduced estimated torque resistance value, an anomaly of excessive lubrication because of entry of oil in a bearing, for example, or the like.

The diagnosis method according to the present disclosure is a diagnosis method for diagnosing a driven member having a rotary shaft, the driven member is rotated by driving of an externally mounted motor, and the diagnosis method includes: calculating an estimated torque resistance value of a combination of the driven member and the motor based on actual operation data obtained by driving the driven member by using the motor and finding a driven member and motor three-dimensional table that is a three-dimensional table of angles, angular velocities, and the estimated torque resistance value; finding a reference-state three-dimensional table that is a three-dimensional table of angles, angular velocities, and estimated torque resistance values in a reference state; and calculating a determination three-dimensional table from a difference between the driven member and motor three-dimensional table and the reference-state three-dimensional table.

Further, in the diagnosis method according to the present disclosure, the reference-state three-dimensional table is a motor three-dimensional table that is a three-dimensional table of angles, angular velocities, and a motor estimated torque resistance value found by calculating the motor estimated torque resistance value of the motor based on motor operation data obtained by driving only the motor, and the diagnosis method includes calculating a driven member three-dimensional table, which is the determination three-dimensional table, from a difference between the driven member and motor three-dimensional table and the motor three-dimensional table.

Further, in the diagnosis method according to the present disclosure, the reference-state three-dimensional table is a predetermined-state driven member and motor three-dimensional table that is a three-dimensional table of angles, angular velocities, and a predetermined-state estimated torque resistance value found by calculating the predetermined-state estimated torque resistance value of a combination of the driven member and the motor based on a predetermined-state operation data obtained by driving the driven member by using the motor in a set predetermined state, and the diagnosis method includes calculating a driven member and motor displacement three-dimensional table, which is the determination three-dimensional table, from a difference between the driven member and motor three-dimensional table and the predetermined-state driven member and motor three-dimensional table.

The diagnosis program according to the present disclosure is a diagnosis program for diagnosing a driven member having a rotary shaft, the driven member is rotated by driving of an externally mounted motor, and the diagnosis program includes steps of: calculating an estimated torque resistance value of a combination of the driven member and the motor based on actual operation data obtained by driving the driven member by using the motor and finding a driven member and motor three-dimensional table that is a three-dimensional table of angles, angular velocities, and the estimated torque resistance value; finding a reference-state three-dimensional table that is a three-dimensional table of angles, angular velocities, and estimated torque resistance values in a reference state; and calculating a determination three-dimensional table from a difference between the driven member and motor three-dimensional table and the reference-state three-dimensional table.

Further, in the diagnosis program according to the present disclosure, the reference-state three-dimensional table is a motor three-dimensional table that is a three-dimensional table of angles, angular velocities, and a motor estimated torque resistance value found by calculating the motor estimated torque resistance value of the motor based on motor operation data obtained by driving only the motor, and the diagnosis program includes a step of calculating a driven member three-dimensional table, which is the determination three-dimensional table, from a difference between the driven member and motor three-dimensional table and the motor three-dimensional table.

Further, in the diagnosis program according to the present disclosure, the reference-state three-dimensional table is a predetermined-state driven member and motor three-dimensional table that is a three-dimensional table of angles, angular velocities, and a predetermined-state estimated torque resistance value found by calculating the predetermined-state estimated torque resistance value of a combination of the driven member and the motor based on a predetermined-state operation data obtained by driving the driven member by using the motor in a set predetermined state, and the diagnosis program includes a step of calculating a driven member and motor displacement three-dimensional table, which is the determination three-dimensional table, from a difference between the driven member and motor three-dimensional table and the predetermined-state driven member and motor three-dimensional table.

Although some embodiments of the present disclosure have been described above in detail with reference to the drawings, the specific configuration is not limited to these embodiments.

For example, although the maximum value is extracted out of estimated torque resistance values within each of equally divided angular ranges in each embodiment described above, the minimum value instead of the maximum value may be extracted. When the minimum value is extracted, the minimum value is extracted out of the estimated torque resistance values and calculated as an estimated torque resistance value. This can make it easier to detect an anomaly of a locally reduced estimated torque resistance value, an anomaly of excessive lubrication because of entry of oil in a bearing of the driven member 10, for example, or the like.

Further, although a calculated three-dimensional table of displacements is compared with the average value of estimated torque resistance values at each angular velocity to evaluate variation in displacements for each angle in the embodiments described above, a calculated three-dimensional table for the driven member 10 may be compared with the average value of estimated torque resistance values at each angular velocity to evaluate variation in displacements for each angle. In such a case, it is possible to evaluate accurate variation in displacements for each angle limited to the driven member 10 and thus contribute to identification of the position of an anomaly and the cause of the anomaly.

### LIST OF REFERENCE NUMERALS

10 driven member
20 motor
50 diagnosis device

What is claimed is:

1. A diagnosis device configured to diagnose a driven member having a rotary shaft, wherein the driven member is rotated by driving of an externally mounted motor, and
the diagnosis device being configured to:
calculate an estimated torque resistance value of a combination of the driven member and the motor based on actual operation data obtained by driving the driven member by using the motor and find a driven member and motor three-dimensional table that is a three-dimensional table of angles, angular velocities, and the estimated torque resistance value;
find a reference-state three-dimensional table that is a three-dimensional table of angles, angular velocities, and estimated torque resistance values in a reference state; and
calculate a determination three-dimensional table from a difference between the driven member and motor three-dimensional table and the reference-state three-dimensional table.

2. The diagnosis device according to claim 1, wherein the diagnosis device is configured to:
define, as a predetermined threshold distribution, a distribution of thresholds for estimated torque resistance values in a normal state based on a normal-state three-dimensional table that is a three-dimensional table of angles, angular velocities, and estimated torque resistance values in a normal state, which is not an abnormal state, and
compare the determination three-dimensional table found based on the actual operation data with the predetermined threshold distribution to output a comparison result in binary values.

3. The diagnosis device according to claim 1,
wherein the reference-state three-dimensional table is a motor three-dimensional table that is a three-dimensional table of angles, angular velocities, and a motor estimated torque resistance value found by calculating the motor estimated torque resistance value of the motor based on motor operation data obtained by driving only the motor, and
wherein the diagnosis device is configured to calculate a driven member three-dimensional table, which is the determination three-dimensional table, from a difference between the driven member and motor three-dimensional table and the motor three-dimensional table.

4. The diagnosis device according to claim 3, wherein the diagnosis device is configured to:
calculate a driven member average estimated torque resistance value, which is an average value of estimated torque resistance values of the driven member, for each of the angular velocities, and
calculate a driven member displacement three-dimensional table from a difference between the driven member three-dimensional table and the driven member average estimated torque resistance value.

5. The diagnosis device according to claim 1,
wherein the reference-state three-dimensional table is a predetermined-state driven member and motor three-dimensional table that is a three-dimensional table of angles, angular velocities, and a predetermined-state estimated torque resistance value found by calculating the predetermined-state estimated torque resistance value of a combination of the driven member and the motor based on a predetermined-state operation data obtained by driving the driven member by using the motor in a set predetermined state, and
wherein the diagnosis device is configured to calculate a driven member and motor displacement three-dimensional table, which is the determination three-dimensional table, from a difference between the driven member and motor three-dimensional table and the predetermined-state driven member and motor three-dimensional table.

6. The diagnosis device according to claim 5, wherein the diagnosis device is configured to:
calculate a driven member and motor average estimated torque resistance value that is an average value of estimated torque resistance values of the driven member and the motor for each of the angular velocities, and
calculate a driven member and motor displacement three-dimensional table from a difference between the driven member and motor displacement three-dimensional table and the driven member and motor average estimated torque resistance value.

7. The diagnosis device according to claim 1,
wherein the actual operation data is data on the angles and the estimated torque resistance values acquired for each of the angular velocities, and
wherein the maximum value is extracted out of the estimated torque resistance values within each of equally divided angular ranges and calculated as the estimated torque resistance value.

8. The diagnosis device according to claim 1,
wherein the actual operation data is data on the angles and the estimated torque resistance values acquired for each of the angular velocities, and
wherein the minimum value is extracted out of the estimated torque resistance values within each of equally divided angular ranges and calculated as the estimated torque resistance value.

9. A diagnosis method for diagnosing a driven member having a rotary shaft, wherein the driven member is rotated by driving of an externally mounted motor,
the diagnosis method comprising:
calculating an estimated torque resistance value of a combination of the driven member and the motor based on actual operation data obtained by driving the driven member by using the motor and finding a driven member and motor three-dimensional table that is a three-dimensional table of angles, angular velocities, and the estimated torque resistance value;
finding a reference-state three-dimensional table that is a three-dimensional table of angles, angular velocities, and estimated torque resistance values in a reference state; and
calculating a determination three-dimensional table from a difference between the driven member and motor three-dimensional table and the reference-state three-dimensional table.

10. The diagnosis method according to claim 9, wherein the reference-state three-dimensional table is a motor three-dimensional table that is a three-dimensional table of angles, angular velocities, and a motor estimated torque resistance value found by calculating the motor estimated torque resistance value of the motor based on motor operation data obtained by driving only the motor,
the diagnosis method further comprising calculating a driven member three-dimensional table, which is the determination three-dimensional table, from a difference between the driven member and motor three-dimensional table and the motor three-dimensional table.

11. The diagnosis method according to claim 9, wherein the reference-state three-dimensional table is a predetermined-state driven member and motor three-dimensional table that is a three-dimensional table of angles, angular velocities, and a predetermined-state estimated torque resistance value found by calculating the predetermined-state estimated torque resistance value of a combination of the driven member and the motor based on a predetermined-state operation data obtained by driving the driven member by using the motor in a set predetermined state,
the diagnosis method further comprising calculating a driven member and motor displacement three-dimensional table, which is the determination three-dimensional table, from a difference between the driven member and motor three-dimensional table and the predetermined-state driven member and motor three-dimensional table.

12. A diagnosis program for diagnosing a driven member having a rotary shaft, wherein the driven member is rotated by driving of an externally mounted motor,
the diagnosis program comprising steps of:
calculating an estimated torque resistance value of a combination of the driven member and the motor based on actual operation data obtained by driving the driven member by using the motor and finding a driven member and motor three-dimensional table that is a three-dimensional table of angles, angular velocities, and the estimated torque resistance value;
finding a reference-state three-dimensional table that is a three-dimensional table of angles, angular velocities, and estimated torque resistance values in a reference state; and
calculating a determination three-dimensional table from a difference between the driven member and motor three-dimensional table and the reference-state three-dimensional table.

13. The diagnosis program according to claim 12, wherein the reference-state three-dimensional table is a motor three-dimensional table that is a three-dimensional table of angles, angular velocities, and a motor estimated torque resistance value found by calculating the motor estimated torque resistance value of the motor based on motor operation data obtained by driving only the motor,
the diagnosis program further comprising a step of calculating a driven member three-dimensional table, which is the determination three-dimensional table, from a difference between the driven member and motor three-dimensional table and the motor three-dimensional table.

14. The diagnosis program according to claim 12, wherein the reference-state three-dimensional table is a predetermined-state driven member and motor three-dimensional table that is a three-dimensional table of angles, angular velocities, and a predetermined-state estimated torque resistance value found by calculating the predetermined-state estimated torque resistance value of a combination of the driven member and the motor based on a predetermined-state operation data obtained by driving the driven member by using the motor in a set predetermined state,
the diagnosis program further comprising a step of calculating a driven member and motor displacement three-dimensional table, which is the determination three-dimensional table, from a difference between the driven member and motor three-dimensional table and the predetermined-state driven member and motor three-dimensional table.
